(19) United States
(12) Patent Application Publication
(10) Pub. No.: US 2005/0004842 A1
(43) Pub. Date: Jan. 6, 2005

(54) Business method for selling advertisements and traffic related services on electronic billboards

(76) Inventor: Neil Mammen, San Jose, CA (US)

Correspondence Address: Neil Mammen, 3645 Copperfield Dr., #305, San Jose, CA, 95136, US

(21) Appl. No.: 10/897,652

(22) Filed: Jul. 1, 2004

Related U.S. Application Data
(60) Provisional application No. 60/485,011, filed on Jul. 5, 2003.

(51) Int. Cl. G06F 17/60; G09F 15/00

(52) U.S. Cl. 705/14

(57) ABSTRACT

A business method designed to utilize electronic billboards to sell advertisements and traffic information.

### RELATED SERVICES ON ELECTRONIC BILLBOARDS CLAIM OF PRIORITY

This patent application claims priority to the provisional application filed on or about Jul. 5, 2003 with application No. 60/485,011 and incorporates the entire application herein.

### FIELD OF THE INVENTION

The invention herein disclosed describes an exemplary method of using electronic billboards to sell advertisements and traffic related services.

### BACKGROUND

Traditionally, large scale outdoor billboard owners have derived revenue from selling static advertising space on their billboards to one customer at a time. This revenue model depends upon the financial ability and willingness of a sole advertiser to bear the financial burden of creating and deploying the advertisement. The monthly rental for one large scale outdoor billboard can easily exceed five thousand ($5,000) dollars per month. With a traditional advertising budget limited to five percent of gross revenues, a business would have to enjoy gross revenues of one hundred thousand ($100,000.00) dollars monthly to justify such expenditure. Further, that would leave no remaining advertising funds for additional venues.

An additional burden to the use of the large scale outdoor billboard advertising medium is the high labor costs of changing the advertisement. One or more persons must be dispatched to remove the current advertisement and place the new advertisement.

Large scale outdoor billboard advertising is prohibitively expensive for most businesses. The Small Business Act defines a small business concern is “one that is independently owned and operated and which is not dominant in its field of operation.” Such a business cannot avail itself of large scale outdoor billboard advertising.

The effectiveness of billboard advertising is limited. Consumers know that billboards contain mostly advertising. Thus, many consumers are inclined to ignore billboards completely. Further, a given billboard may have the same advertisement for months or years, thus repeat travelers become oblivious to the specific billboard even when the advertisement is changed.

Another type of billboard is the electronic sign often used by public agencies to display traffic information. These electronic signs typically are low resolution; block based, and displays only text information. The limited resolution of these electronic signs prevents the recognition of significant advertising revenue.

The next generation of large scale outdoor billboards is the electronic billboard. Electronic billboards employ high resolution display units capable of presenting hi-resolution color graphics and text. A typical large scale outdoor electronic billboard is capable of displaying millions of colors over a usable screen area of several hundred square feet. These billboards are capable of changing the displayed message as needed. This functionality enables the billboard owner to place constantly changing information on the electronic billboard. However, the revenue model has not changed as technology improved. Most electronic billboards only display variations of the advertisements from one large corporate advertiser. The small to medium size businesses market remains untapped.

### DESCRIPTION OF THE TECHNICAL COMPONENTS

The invention disclosed herein combines the public service message information of public electronic signs, with the commercial aspects of the large scale outdoor electronic billboards to create a new revenue model. Specifically, the invention consists of a series of electronic billboards placed at strategic locations, which have been configured to display both public safety information as well as commercial advertisements.

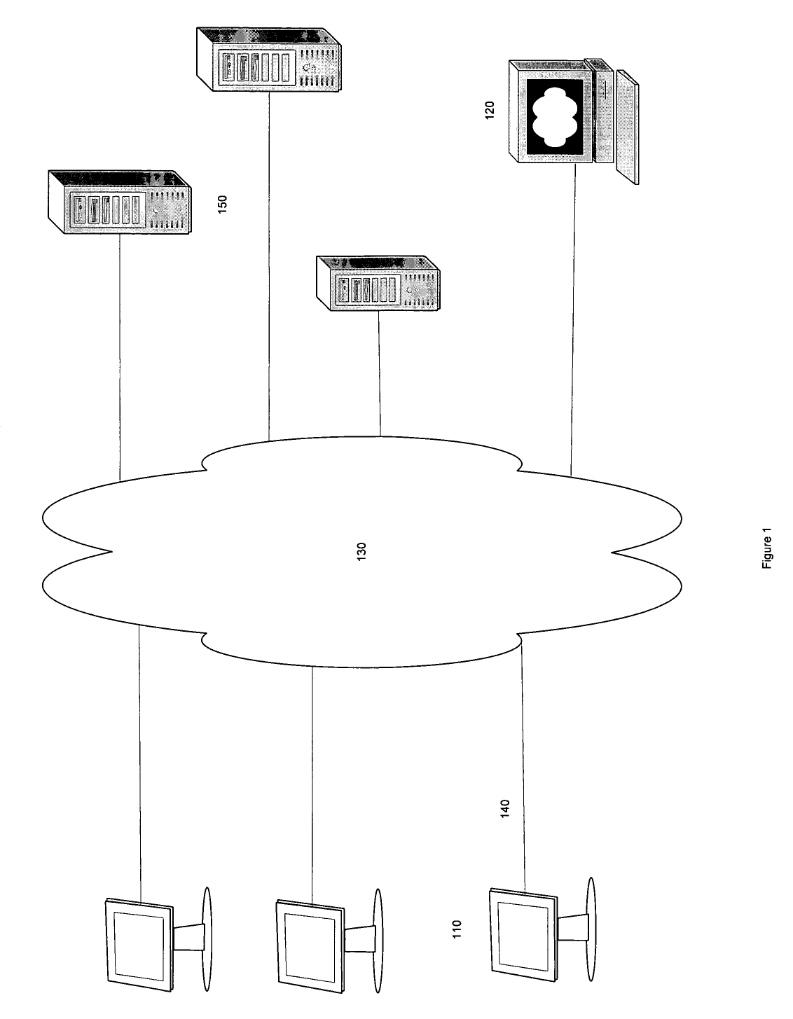

Referring to FIG. 1, the technical components of the invention consist of one or more web-enabled electronic billboards (110), a computer system (120) including hardware, software, a means to reach the internet (130) such as a modem (140) or broadband connection, and one of more third party servers (150). For purposes of the description, a web enabled device is any device capable of connecting to the Internet and receiving or transmitting information through the internet.

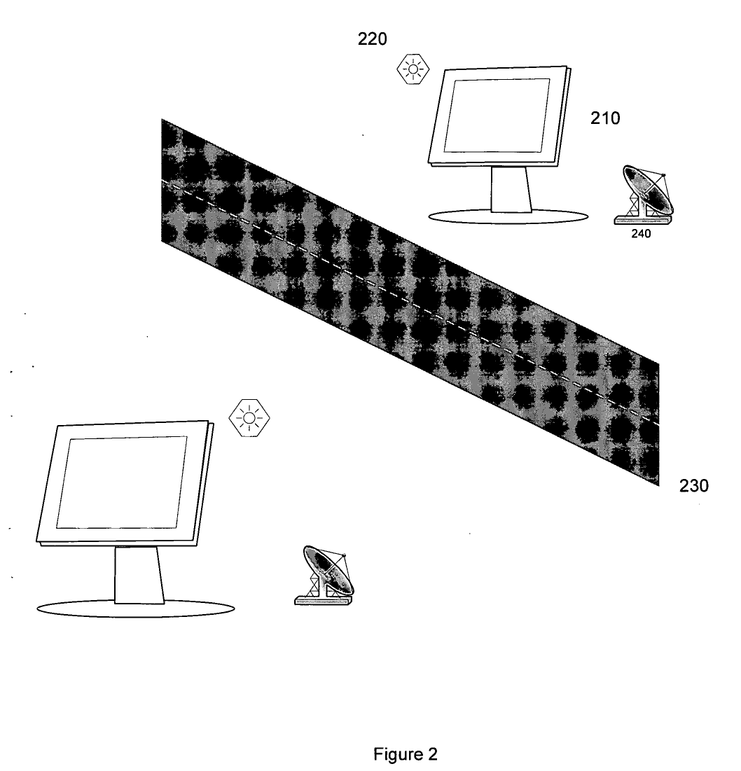

Referring to FIG. 2, in another embodiment of the invention, the invention additionally includes one or more electronic sensors (220), mounted on or near the electronic billboards (210), near the public thoroughfare (230) configured to read traffic conditions, and software designed to collate traffic condition data and integrate it into one or more driving directions databases.

In yet a further embodiment of the invention, the invention adds a transmitter (240), mounted at or near each electronic billboard, configured to broadcast traffic alerts to subscriber messengering devices such as cell phones, pagers, and pda's.

### DETAILED DESCRIPTION

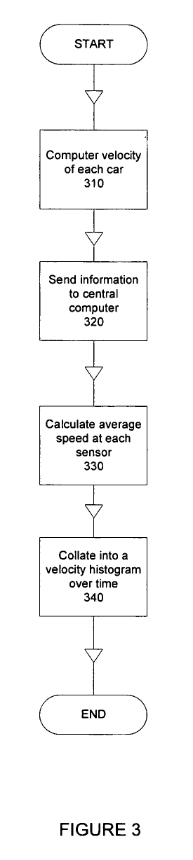

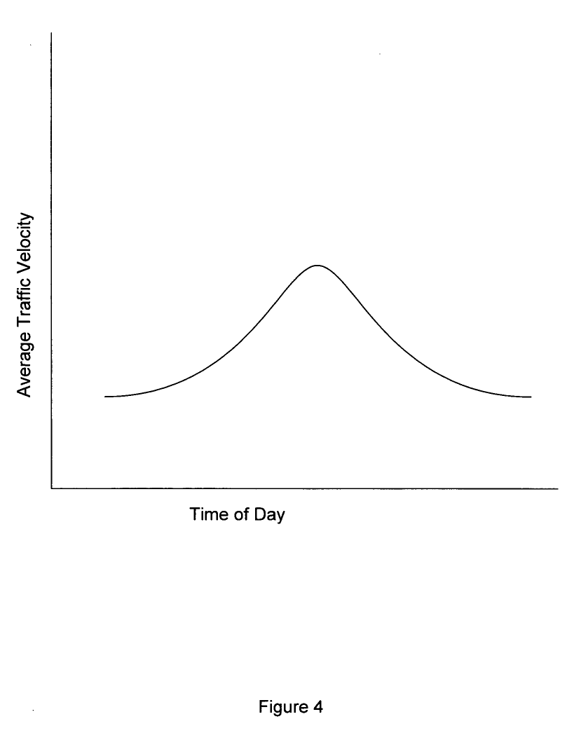

FIG. 3 illustrates one embodiment of the creation of a traffic histogram database. At Step 310 each sensor collects the length of each car traveling past it as well as the time it takes for the car to pass said sensor. At step 320, this information is sent to the computer system. At step 330, the computer calculates the computes the average traffic speed, at each sensor, as a function of time as:
Speed=car length/(T₍ᵣₑₐᵣ₎−T_{(front)})
Thus, the average traffic speed per unit time is calculated as
Avg Speed=[ρ_{speed})/number of cars]
At step 340 the computer system collates the data into a speed profile at each sensor. FIG. 4 illustrates this graph. The horizontal axis represents the time of day; the vertical axis represents the average traffic speed.

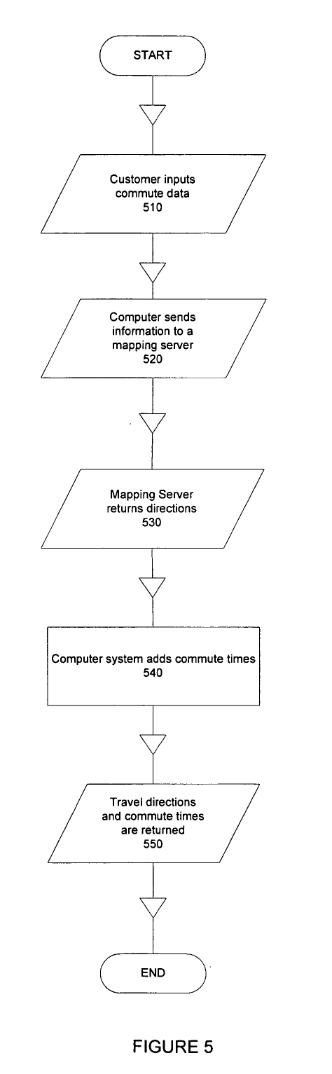

FIG. 5 illustrates one embodiment of a mapping system incorporating the function of delivering estimated commute times based upon the time of departure. At step 510, the user enters the commute information into the computer. The commute information includes the origination point, the destination point, and the time of departure. The computer system sends the request without the time of departure to a mapping server in step 520. At step 530, the mapping server returns driving directions to the computer system. At step 540, the computer system obtains the speed profiles and determines an estimated commute time for each leg based upon the anticipated departure time. The total commute time is determined by summing the commute times of each leg. In one embodiment, this commute time of each leg is determined by creating a weighted average of the traffic speeds at each sensor location along the leg and multiplying by the distance of said leg. At step 550, the directions and anticipated commute times are returned to the user.

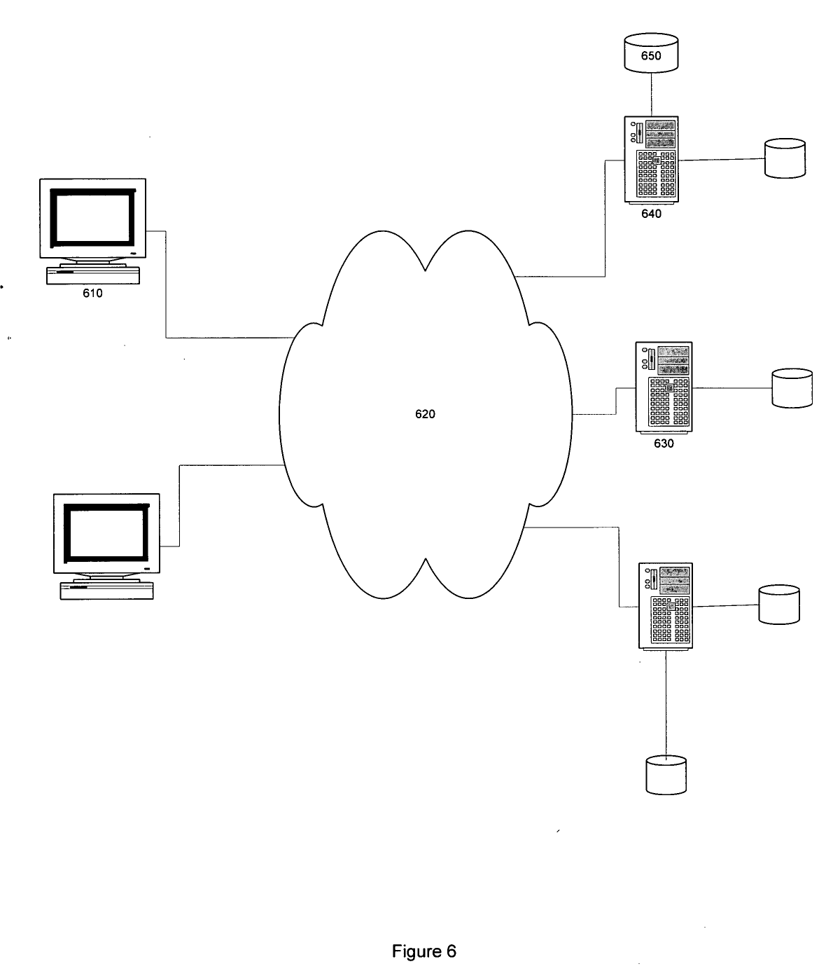

FIG. 6 illustrates one embodiment of the technical components of this system. The user enters the relevant commute information at terminal 610 which is connected to the public internet 620. The computer system 630 receives the users' request via the public internet and sends the mapping requests to servers 640 as needed. Servers 640 are connected to database 650 which store all of the information needed by the system. Servers 640 return the information which is collated at computer system 630 and transferred back to the user at terminal 610.

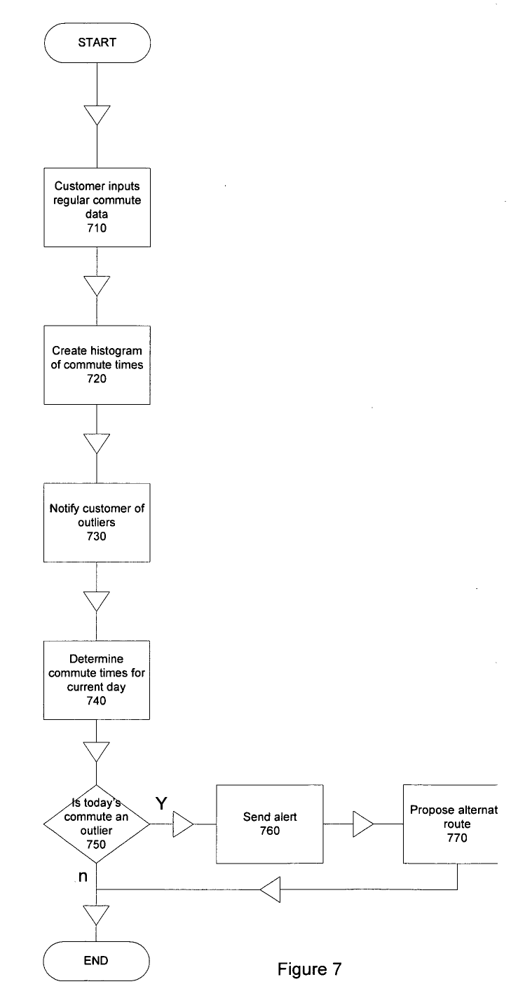

FIG. 7 illustrates one embodiment of the traffic alert system. At step 710, the user enters his regular commute information. This information includes, the origination point, the destination point, the time of departure, as well as which days the commute occurs, i.e. weekdays, weekends, etc. At step 720, using the method outlines in FIG. 5, the computer system creates a profile of the average commute for this user. This profile is based upon the historical traffic patterns for said route. At step 730, the computer system determines the average commute time and instantly alerts the user of any days when the commute might be substantially longer than normal based upon statistical information.

At step 740, the computer system determines the anticipated commute for the current day. At 750 the computer system determines if the daily commute is substantially longer than the average. If yes, then at step 760 the computer sends an alert and an alternative route to the user. If no, then no alerts are sent regarding the current day's commute.

Further, any user can contact the system and receive updated traffic alerts as desired. Such databases would be accessible via telephone and internet.

### DESCRIPTION OF THE REVENUE MODEL

The invention disclosed herein relates to an exemplary method and apparatus for selling advertisement space and time via outdoor electronic billboards. This method is exemplary in that it increases the number of advertisements sold. Further, this method increased the base of potential advertisers to include small and medium sized business who previously could not avail themselves of the opportunities provided by outdoor advertising.

This invention is further exemplary by reducing the problem of driver apathy; specifically, by combining public service messages with the dynamic nature of an electronic billboard, drivers are substantially more inclined to pay attention to said billboards over traditional static outdoor billboards. These public service announcements, include, but are not limited to, amber alerts, weather alerts, road congestion, and detour information.

The invention herein described also increased the number of potential advertisers because set-up costs are greatly reduced and short term contracts are possible. Traditionally, an advertiser would have to hire the services of an expensive ad agency to create the ad, as well as hire persons to physically place the ad on the billboard. In the current invention, the user can transmit a graphical file to the server and upon approval it can be instantly programmed into the electronic billboard. Further, revisions to the ad are a matter of transmitting a new file, thus permitting the user to revise the ad as often as desired at little or no cost

In the current invention, billboard advertising is sold as a function of display time and display space, e.g. the greater the percentage of used billboard or the longer the ad is displayed, the greater the cost to the advertiser.

In a further embodiment of the invention, different locations on the billboard are charged different rates. Certain locations may be considered more or less desirable than others and as such a different rate would apply.

In yet another embodiment of the invention, different times of days are considered more or less desirable and as such, different rates would apply at different times of day.

In yet another embodiment of the invention, an advertiser could pay a premium to restrict competitive advertisements appearing during certain times.

In yet a further embodiment of the invention, billboards at different locations would charge different prices based upon the desirability and traffic, both pedestrian and vehicular traffic.

In yet a further embodiment of the invention, the invention would permit a pricing option for advertisers to display their ads during and after a public service announcement.

In yet another embodiment of the invention, the invention permits running ads based upon the estimated or actual speed of the drivers. For purposes of this disclosure, a running ad would be one that display on a series of billboards placed one after the other along a highway. The rate at which the next ad would display on the next billboard would be based on the speed of the traffic such that the driver of a vehicle would see them in sequence if he maintained his speed.

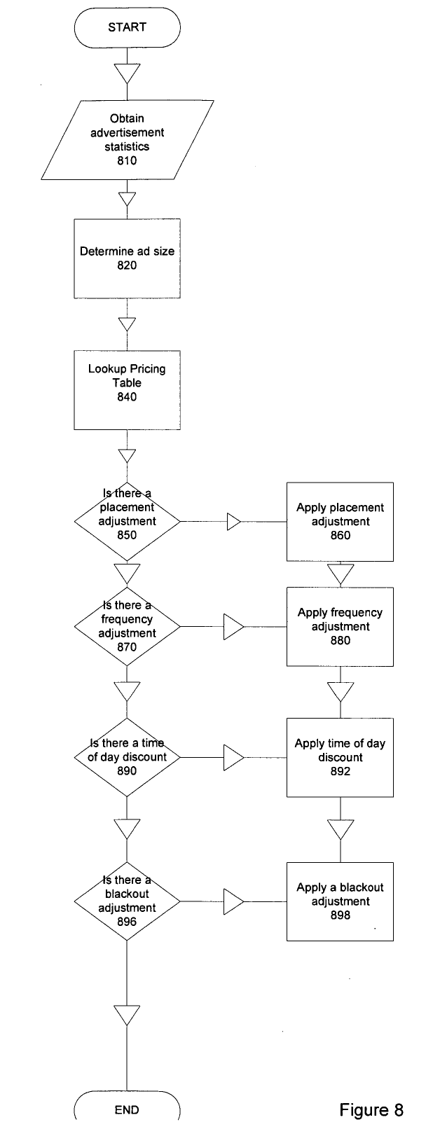

Referring to FIG. 8. At step 810 the pricing software considers a potential advertisement. At step 820 it determines the amount of physical real-estate on the electronic billboard needed. At step 830, the pricing software considered the length of time the advertisement will be displayed on the billboard. At step 840, the pricing software uses a look-up table to determine the price to display said advertisement once. At step 850 the pricing software determines if a placement adjustment to the price is warranted. If yes, then at step 860 the price is adjusted to reflect the placement adjustment. If no, then at step 870, the pricing software determines whether a frequency adjustment to the price is required. If yes, then at step 880, the frequency adjustment is applied. If not, then at step 890, the pricing software determines whether a time of day adjustment is needed. If yes, then at step 895, the pricing software applied the time of day adjustment. If no, the at step 896, the pricing software determines if a competitive blackout charge is to be applied. If yes, then at step 897, the competitive blackout charge is added. If no, the price for the ad is completed at step 898.

As yet a further embodiment, the invention allows consumers to purchase real-time commuter mapping. The mapping module would be sold via subscriptions tiers. At one tier, the consumer would be able to request driving instructions and the best route for the current conditions would be displayed. At another tier, the consumer would request driving directions for a future time. The mapping module would combine current and historical data to determine the best and alternative routes and times. At yet another tier, the consumer could purchase alerts, thus when the consumers normal commute should be altered due to traffic concerns, the consumer would be alerted via any communication method including, but not limited to cell phone, e-mail, land-line phone, pager, etc. Each tier or combination of tiers could also be purchased on a one-time basis.

In another embodiment of the invention, the collate highway speed data could be sold to urban planners, both public and private for the purpose of planning or revising an infrastructure. This data would be instrument in determine the location of future thoroughfares as well a future commerce centers.

### SUMMARY

The present invention embodies a means and apparatus to sell advertisements via electronic billboards. These advertisements are made more effective by combining them with public service announcement such as traffic and weather information, Amber alerts, and road conditions. These outdoor advertisements are made affordable to a wider range of business because each advertiser bears only its fractional share of the time the billboard is displaying the ads. Similarly, advertisers can elect different display options such as time, location, frequency, and so forth to determine the optimum expenditures.

1. An advertisement selling system configured to reduce human interaction in the sale and placement of advertisements for outdoor electronic billboards, and encourage greater viewership of advertisements, comprising an advertisement interface to receive advertisements in machine readable format; said advertisement interface also configured to receive the display parameters for said advertisements; an outdoor, hi-resolution, electronic billboard configured to display said advertisements; a means of connectivity to a wide area network; and a pricing algorithm configured to dynamically price the cost of displaying said received advertisements according to the various display parameters.

2. The advertisement selling system of claim 1 where the electronic billboard simultaneously displays advertisements from more than one advertiser.

3. The advertisement selling system of claim 2 where the advertisements from different advertisers are displayed for different lengths of time.

4. The advertisements selling system of claim 1, where the advertiser uploads the proposed advertisement through the advertiser interface.

5. The advertisement selling system of claim 1, where the pricing module determines a price for the advertisement.

6. The advertisement selling system of claim 5, where the pricing module adjusts the price of the advertisement based upon the placement of the advertisement on the billboard.

7. The advertisement selling system of claim 5, where the pricing module adjusts the price of the advertisement based upon the time of day the advertisement is being displayed.

8. The advertisement selling system of claim 5, where the pricing module adjusts the price of the advertisements based upon how often the advertisement is displayed.

9. The advertisement selling system of claim 5, where the pricing module adjusts the price of the advertisement based upon the advertiser requesting that certain types of advertisements not be displayed during a surrounding time interval of the advertiser's ad being displayed; where said pricing module adjusts the price of the advertisement depending on the length of said time interval.

10. The advertisement selling system of claim 2, where the pricing modules adjusts the price for rotating advertisements on the same electronic billboard.

11. The advertisement selling system of claim 2 where the electronic billboards are configured to displays public service information simultaneously with commercial advertisements.

12. The advertising selling system of claim 11, where the pricing module adjusts the price for advertisements to be displayed simultaneously with public service announcements.

13. The advertising selling system of claim 11, where the pricing module adjusts the price for advertisements to be displayed immediately after a public service announcement.

14. The advertisement selling system of claim 1, where the pricing module partially adjusts the price for advertisements based upon the desirability of the location of the billboards.

15. The advertisement selling system of claim 1, where the pricing unit adjusts the price for running ads.

16. A system for providing driving directions to commuters, where the driving directions change dynamically to reflect the real-world driving conditions, comprising one of more sensors placed along the public thoroughfare configured to continuously determine traffic volume; connectivity to a first server configured to collate the sensor data into a dynamic traffic velocity/commute time database; a second server configured as a mapping server; a computer system configured to send driving direction requests to the first server and receive a driving directions from said first server; said computer system also configured to obtain commute times for each segment of the commute; and connectivity to a wide area decentralized network.

17. The system of claim 16 where the first and second servers are the same server.

18. The system of claim 16 where the sensors are mounted on electronic billboards.

19. The system of claim 16 where the traffic velocity/commute time database includes different commute times for different times of day.

20. The system of claim 19, where the traffic velocity/commute time database includes historical data.

21. The system of claim 16, where the commuter receives an estimated commute time based upon the current traffic velocity.

22. The system of claim 16, where the system compares the estimated commute time with the average commute time and alerts the commuter if the estimated commute time is significantly longer than usual.

23. The system of claim 16 where the commuter can request driving directions for a future time.

24. The system of claim 16, where the commuter submits a regular commute to the system to receive automatic traffic alerts whenever said regular commute is anticipated to be significantly longer than usual.

25. The system of claim 16, where said alert is received via any web-enabled device.

26. The system of claim 16, further where the sensors have wireless transmission capability.

27. The system of claim 17, where the sensors wirelessly transmits traffic alerts to subscribers of the system about traffic problems in the vicinity of the sensor.
